(19) United States
(12) Patent Application Publication
(10) Pub. No.: US 2020/0323220 A1
(43) Pub. Date: Oct. 15, 2020

(54) BIOCIDAL PESTICIDE COMPOSITION SUSPENDED IN A PLANT OIL BASED EMULSION AND MANUFACTURING METHOD THEREOF

(71) Applicant: LIREN BIO CO., LTD., Changwon-si Gyeongsangnam-do (KR)

(72) Inventor: Bong Ki KIM, Changwon-si Gyeongsangnam-do (KR)

(21) Appl. No.: 16/912,404

(22) Filed: Jun. 25, 2020

Related U.S. Application Data
(62) Division of application No. 15/777,405, filed on May 18, 2018.

(30) Foreign Application Priority Data
Nov. 9, 2016 (KR) 10-2016-0148643
Apr. 14, 2017 (KR) 10-2017-0048302

(51) Int. Cl. A01N 65/08; A01N 65/24; A01N 25/04; A01N 65/20; A01N 65/12; A01N 65/42; A01N 65/06

(52) U.S. Cl. CPC A01N 65/08; A01N 65/24; A01N 25/04; A01N 65/20; Y02A 50/348; A01N 65/42; A01N 65/06; Y02A 50/335; A01N 65/12

(57) ABSTRACT

The present invention relates to a biocidal pesticide composition comprising a fungicidal or insecticidal active herbal extract suspended in plant oil based emulsion containing plant oil, emulsifier and water, and a method for producing the same. More particularly, this invention relates to a biocidal pesticide composition comprising 1˜20 wt part of at least one fungicidal or insecticidal herbal extract selected from Phytolaccae Radix, Cinnamomi Cortex Spissus, Artemisiae Iwayomogii Herba or Pulvis Sophorae Radicis suspended in 100 wt part of plant oil based emulsion, and a method for producing the same.

### TECHNICAL FIELD

The present invention relates to a biocidal pesticide composition comprising a fungicidal or insecticidal active herbal extract suspended in plant oil based emulsion containing plant oil, emulsifier and water, and a method for producing the same. More particularly, this invention relates to a biocidal pesticide composition comprising 1˜20 wt part of at least one fungicidal or insecticidal herbal extract selected from Phytolaccae Radix, Cinnamomi Cortex Spissus, Artemisiae Iwayomogii Herba or Pulvis Sophorae Radicis suspended in 100 wt part of plant oil based emulsion, and a method for producing the same.

### DESCRIPTION OF PRIOR ART

Biological pesticides have been called as biological control agent or clean pesticides produced from natural materials derived from living organisms or organisms in nature, which protect the crops from bacteria, fungi, pests, and weeds that damage the production and preservation.

In recent years, there has been a growing interest in plant-derived or microbial-derived biological pesticides. Further, there have been continuous researches to extract and/or isolate a biological pesticide component from native plants since 2000 in Korea.

Plant-derived antimicrobial or antifungal substance for biocidal pesticide has been reported by following documents. Cinnamaldehyde derived from Cassia tora has been reported to exhibit antifungal and insecticidal effects from Kim, Young Mi et al., J. Agric. Food Chem., 52(20) (2004) pp. 6096-6100, while 97.5% jojoba oil derived from the shrub johnbaem (Simmondsia californica) has been also reported to exhibit antifungal and insecticidal effects from Abbassya et al., Industrial Crops and Products 26 (2007) pp. 345-350.

On the other hand, 1.5% aqueous extract of Macleaya cordata has been reported to exhibit antifungal effect from Mi-Young Yoon et al., Plant Pathology Journal 29(1) (2013) pp. 1-9, while 5% ethanol extract of Reynoutria sachalinensis also has been reported to exhibit antifungal effect from Konstantinidou-Doltsinis et al., BioControl 51(3) (2006) pp. 375-392.

Further, in Korean Laid-Open Patent Publication No. 10-2005-58782 ‘Environment-friendly agent having excellent fungicidal and insecticidal activity and method for preparing the same’, a plant oil-based emulsion containing plant oil, emulsifier and water has been disclosed as fungicide and insecticide. Further, such plant oil-based emulsion requires the specific oil particles having the particle diameter of 20˜50 nm for showing the fungicidal ord insecticidal activity.

In the case of the ‘fungicidal and insecticidal agent’ disclosed in the above patent document, only the fungicidal or insecticidal activity of a plant oil, such as soybean oil, based emulsion has been employed. However, such agent has not shown a fungicidal or insecticidal activity effective against various fungi and insects.

Upon enhancing the fungicidal or insecticidal activity of above mentioned agent, the inventor of present invention has developed and completed a biocidal pesticide composition suspended in a plant oil based emulsion, wherein said composition is prepared by suspending 1˜20 wt part of at least one fungicidal or insecticidal herbal extract selected from Phytolaccae Radix, Cinnamomi Cortex Spissus, Artemisiae Iwayomogii Herba or Pulvis Sophorae Radicis as to 100 wt part of plant oil based emulsion.

### Problem to be Solved

The problem to be solved is to develop a fungicidal or insecticidal composition of a plant oil based emulsion upon suspending various kinds of fungicidal or insecticidal herb extracts. Further, it is also intend to measure the fungicidal or insecticidal activity of plant oil based emulsion suspending at least one herbal extract selected from Phytolaccae Radix, Cinnamomi Cortex Spissus, Artemisiae Iwayomogii Herba or Pulvis Sophorae Radicis.

### Means for Solving the Problem

The object of present invention is to provide a biocidal pesticide composition having fungicidal or insecticidal activity comprising 1˜20 wt part of at least one 95% of herbal ethanol extract selected from Phytolaccae Radix, Cinnamomi Cortex Spissus, Artemisiae Iwayomogii Herba or Pulvis Sophorae Radicis suspended in 100 wt part of plant oil based emulsion, wherein said plant oil based emulsion comprises 40˜60 wt % of plant oil, 5˜30 wt % of emulsifier and 20˜55 wt % of water.

Further, said plant oil can be at least one selected from soybean oil, corn oil, canola oil, palm oil, rape seed oil or cotton seed oil, and said emulsifier can be at least one selected from sorbitan fatty acid ester, polyglycerin fatty acid ester or propylene glycol fatty acid monoester.

Further, said plant oil is soybean oil, and said emulsifier is at least one selected from sorbitan laurate, polyglycerol laurate or propylene glycol laurate monoester.

Further, the average particle size of said herbal ethanol extract is 1˜50 micrometers.

On the other hand, the biocidal pesticide composition of the present invention further comprises 0.01˜1.0 wt part of an alkanol alkoxylate penetration promoter represented by the following formula (I) for smooth penetration of biocidal pesticide composition in the crops.

R—O—(—PO—)ₚ-(EO—)_{q}—H Formula I

wherein

R represents a chained or branched alkyl having 4 to 10 carbon atoms,

EO represents

—CH₂—CH₂—O—,

PO represents

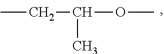

p represents an integer of 1 to 5,

q represents an integer of 1 to 5.

Another object of present invention is to provide a process for preparing a biocidal pesticide composition having fungicidal or insecticidal activity, comprising the steps of: 1) preparing 20˜70 nm of plant oil fine particles after pulverizing the plant oil from the plant oil storage tank (130) in the pulverizer (140); 2) preparing an emulsifier in the emulsifier storage tank (120), and water in the water storage tank (110) respectively; 3) preparing plant oil based upon emulsion upon adding and homogenizing plant oil, emulsifier and water in the mixing tank (150); 4) adding and mixing at least one 95% of herbal ethanol extract selected from Phytolaccae Radix, Cinnamomi Cortex Spissus, Artemisiae Iwayomogii Herba or Pulvis Sophorae Radicis prepared in storage tank (160), if necessary, including a penetration promoter; 5) agitating, dispersing and emulsifying the mixture at 1,000˜1,500 rpm in the homo-agitating part 6) filtering and purifying the obtained emulsion through a carbon filter (170); and 7) softening and cooling the obtained product after passing through a spinning net at a high speed of 10,000˜15,000 rpm.

The other object of present invention is to provide a use of biocidal pesticide composition having fungicidal or insecticidal activity for preventing or controlling at least one selected from Rhizoctonia solani of rice; Cucumber powdery mildew; Black head fungus infected with vegetables, fruits, rice, potatoes, soybeans or tomatoes; Entomosporium leaf spot infected with cereals and vegetables; Powdery mildew infected with cereals; Gray mold infected with strawberry, vegetables, grapes; Downy mildew infected with Lettuce; Entomosporium leaf spot infected with corn, rice and soybean; Stem rot of soybean; Downy mildew of cabbage; Soybean rust of soybean; or Net blotch of wheat and barley.

### Advantageous Effect

The outstanding advantageous effect of the present invention is to provide a fungicidal or insecticidal composition of a plant oil based emulsion upon suspending at least one herbal extract selected from Phytolaccae Radix, Cinnamomi Cortex Spissus, Artemisiae Iwayomogii Herba or Pulvis Sophorae Radicis.

Further, the other outstanding advantageous effect of the present invention is to provide a fungicidal or insecticidal composition useful to at least one selected from Rhizoctonia solani of rice; Cucumber powdery mildew; Black head fungus infected with vegetables, fruits, rice, potatoes, soybeans or tomatoes; Entomosporium leaf spot infected with cereals and vegetables; Powdery mildew infected with cereals; Gray mold infected with strawberry, vegetables, grapes; Downy mildew infected with Lettuce; Entomosporium leaf spot infected with corn, rice and soybean; Stem rot of soybean; Downy mildew of cabbage; Soybean rust of soybean; or Net blotch of wheat and barley.

### BRIEF DESCRIPTION OF DRAWINGS

FIG. 1 is a block diagram showing an outline of the apparatus for manufacturing a biocidal pesticide composition of the present invention.

FIG. 2 is a cross-sectional view of mixing tank (150) showing its structure.

### PREFERRED EMBODIMENT OF INVENTION

The present invention relates to a biocidal pesticide composition having fungicidal or insecticidal activity comprising 1˜20 wt part of at least one 95% of herbal ethanol extract selected from Phytolaccae Radix, Cinnamomi Cortex Spissus, Artemisiae Iwayomogii Herba or Pulvis Sophorae Radicis suspended in 100 wt part of plant oil based emulsion, wherein said plant oil based emulsion comprises 40˜60 wt % of plant oil, 5˜30 wt % of emulsifier and 20˜55 wt % of water.

The present invention also relates to a process for preparing a biocidal pesticide composition having fungicidal or insecticidal activity, comprising the steps of: 1) preparing 20˜70 nm of plant oil fine particles after pulverizing the plant oil from the plant oil storage tank (130) in the pulverizer (140); 2) preparing an emulsifier in the emulsifier storage tank (120), and water in the water storage tank (110) respectively; 3) preparing plant oil based upon emulsion upon adding and homogenizing plant oil, emulsifier and water in the mixing tank (150); 4) adding and mixing at least one 95% of herbal ethanol extract selected from Phytolaccae Radix, Cinnamomi Cortex Spissus, Artemisiae Iwayomogii Herba or Pulvis Sophorae Radicis prepared in storage tank (160), if necessary, including a penetration promoter; 5) agitating, dispersing and emulsifying the mixture at 1,000˜1,500 rpm in the homo-agitating part 6) filtering and purifying the obtained emulsion through a carbon filter (170); and 7) softening and cooling the obtained product after passing through a spinning net at a high speed of 10,000˜15,000 rpm.

Further, this invention also relates to a use of biocidal pesticide composition having fungicidal or insecticidal activity for preventing or controlling at least one selected from Rhizoctonia solani of rice; Cucumber powdery mildew; Black head fungus infected with vegetables, fruits, rice, potatoes, soybeans or tomatoes; Entomosporium leaf spot infected with cereals and vegetables; Powdery mildew infected with cereals; Gray mold infected with strawberry, vegetables, grapes; Downy mildew infected with Lettuce; Entomosporium leaf spot infected with corn, rice and soybean; Stem rot of soybean; Downy mildew of cabbage; Soybean rust of soybean; or Net blotch of wheat and barley.

The present invention can be explained more specifically as follows.

The plant oil used in the present invention can be at least one selected from soybean oil, corn oil, canola oil, palm oil, rape seed oil or cotton seed oil. In particular, oleic acid, linoleic acid and/or linolenic acid having a high content of unsaturated fatty acids is preferred. Further, soybean oil is the most preferred plant oil.

The emulsifier used in the present invention may include at least one emulsifier selected from sorbitan fatty acid ester, polyglycerin fatty acid ester or propylene glycol fatty acid monoester. The most preferred emulsifier is sorbitan fatty acid ester.

Further, the preferred emulsifier can be sorbitan laurate, polyglycerol laurate or propylene glycol laurate monoester.

The plant oil based emulsion used in the present invention can be prepared by agitating and homogenizing 40˜60 wt % of plant oil, 5˜30 wt % of emulsifier and 20˜55 wt % of water.

Subsequently, 1˜20 wt part of the 95% ethanol extract of at least one selected from Phytolaccae Radix, Cinnamomi Cortex Spissus, Artemisiae Iwayomogii Herba or Pulvis Sophorae Radicis can be suspended by mixing and dispersing it in 100 wt part of the obtained plant oil based emulsion.

If required, 0.01˜1.0 wt part of alkanol alkoxylate penetration promoter represented by the following formula I can be additionally added and suspended in the biocidal pesticide composition having fungicidal or insecticidal activity.

R—O—(—PO—)ₚ-(EO—)_{q}—H Formula I

wherein

R represents a chained or branched alkyl having 4 to 10 carbon atoms,

EO represents

—CH₂—CH₂—O—,

PO represents

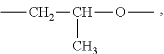

p represents an integer of 1 to 5,

q represents an integer of 1 to 5.

On the other hand, the 95% ethanol extract of at least one selected from Phytolaccae Radix, Cinnamomi Cortex Spissus, Artemisiae Iwayomogii Herba or Pulvis Sophorae Radicis can be prepared by extracting dried and pulverized raw materials in the extractor using the chilled 95% ethanol solvent.

Phytolaccae Radix is a phytolaccaceae plant that uses its roots as medicinal product having a powerful diuretic effect. Further, it can reduce edema in the body by excreting the foreign substances in the body. It can be therefore used as a diuretic. Its pharmacologically active substance include saponin, α-spinasterol, myristic acid, γ-aminobutyric acid, β-sitosterol, and the like.

Cinnamomi Cortex Spissus is bark of cinnamon tree belonging to the genus Lauraceae. Cinnamomi Cortex Spissus has been used as medicines for protecting digestive organs and gastrointestinal tract. It can be also used as various pain analgesics as well as blood circulation remedies. Representative indicator includes cinnamic aldehyde.

Artemisiae Iwayomogii Herba can be referred to as Artemisia capillaris Thunberg, which is a dried ground part of Asteraceae plant. It has been known as antioxidant, antimicrobial agent and/or liver protecting agent. In particular, the ethanol extract of Artemisiae Iwayomogii Herba can exhibit high antimicrobial activity against bacteria such as Bacillus subtilis, Staphylococcus aureus and/or Vibrio parahaemolyticus. Further, chlorogenic acid has been known as its indicator.

Pulvis Sophorae Radicis is the root of Leguminosae plants. It has been used as a nourishing tonic, because it is especially effective into the treatment and prevention of anemia by improving blood circulation. It is also effective for skin diseases such as eczema. It has an indicator substance called matrine.

It is preferable that at least one herbal extract selected from Phytolaccae Radix, Cinnamomi Cortex Spissus, Artemisiae Iwayomogii Herba or Pulvis Sophorae Radicis can be prepared by extracting raw materials using the chilled 95% ethanol solvent for 24˜48 hours at 15˜25° C. Therefore, the pharmacologically active component of one or more herbal extract selected from Phytolaccae Radix, Cinnamomi Cortex Spissus, Artemisiae Iwayomogii Herba or Pulvis Sophorae Radicis can be extracted without any structural change. Finally, all active components can be dissolved in 95% ethanol.

The 95% herbal ethanol extract cannot be miscible with the plant oil based emulsion. However, the aqueous ethanol particles can be dispersed and suspended in colloidal particles in the plant oil based emulsion.

The average suspended particle size of the 95% herbal ethanol extract can be 1˜50 micrometers, preferably 5˜20 micrometers. If the size of suspended particles is larger than 50 micrometers, coagulation and precipitation of suspended particles may occur. On the other hand, when the suspended particle size is smaller than 1 micrometer, it is difficult to exhibit sufficient fungicidal and insecticidal effects of herbal extract.

If necessary, 0.01˜1.0 wt part of the alkanol alkoxylate penetration promoter represented by the following formula I can be additionally added and suspended in the biocidal pesticide composition.

R—O—(—PO—)ₚ-(EO—)_{q}—H Formula I

wherein

R represents a chained or branched alkyl having 4 to 10 carbon atoms,

EO represents

—CH₂—CH₂—O—,

PO represents

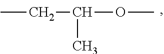

p represents an integer of 1 to 5,

q represents an integer of 1 to 5.

The penetration promoter is intended to promote penetration of the biocidal pesticide composition of the present invention into a crop. The penetration of 95% herbal ethanol extract of at least one selected from Phytolaccae Radix, Cinnamomi Cortex Spissus, Artemisiae Iwayomogii Herba or Pulvis Sophorae Radicis can be promoted with its promoter. Therefore, fungicidal or insecticidal activity of biocidal pesticide composition of the present invention can be promoted. Further, the biocidal pesticide composition of the present invention can effectively control the fungi such as moldy fungus and gray mold.

The kinds of fungi that can be controlled by biocidal pesticide composition of the present invention can be described as follows.

It can be at least one selected from Rhizoctonia solani of rice; Cucumber powdery mildew; Black head fungus infected with vegetables, fruits, rice, potatoes, soybeans or tomatoes; Entomosporium leaf spot infected with cereals and vegetables; Powdery mildew infected with cereals; Gray mold infected with strawberry, vegetables, grapes; Downy mildew infected with Lettuce; Entomosporium leaf spot infected with corn, rice and soybean; Stem rot of soybean; Downy mildew of cabbage; Soybean rust of soybean; or Net blotch of wheat and barley.

The kinds of pests that can be controlled by the biocidal pesticide composition of the present invention can be described as follows.

It can be at least one selected from Trialeurodes vaporariorum, a cockchafer, cockroach, termite, aphid or diamondback moth.

The method for producing the biocidal pesticide composition of the present invention can be described as follows.

(Step 1) Preparation of plant oil based emulsion by mixing and agitating plant oil, emulsifier and water in the mixing tank

Step 1 includes the following 3 sub-steps.

[Sub-step 1] 40˜60 wt % plant oil fine particles having 20˜70 nm of oil particle size has been prepared after pulverizing the plant oil from the plant oil storage tank (130) in the pulverizer (140);

[Sub-step 2] 5˜30 wt % of an emulsifier in the emulsifier storage tank (120) and 20˜55 wt % of water in the water storage tank (110) have been prepared respectively; and

[Sub-step 3] plant oil based upon emulsion has been prepared upon adding and homogenizing plant oil, emulsifier and water in the mixing tank (150).

(Step 2) Adding and mixing at least one 95% of herbal ethanol extract selected from Phytolaccae Radix, Cinnamomi Cortex Spissus, Artemisiae Iwayomogii Herba or Pulvis Sophorae Radicis prepared in storage tank (160), if necessary, including a penetration promoter

In this step, 1˜20 wt part of at least one 95% herbal ethanol extract selected from Phytolaccae Radix, Cinnamomi Cortex Spissus, Artemisiae Iwayomogii Herba or Pulvis Sophorae Radicis has been suspended in 100 wt part of plant oil based emulsion obtained in Step 1. Further, if necessary, 0.01˜1.0 wt part of an alkanol alkoxylate penetration promoter represented by the following formula (I) can be additionally added and mixed.

R—O—(—PO—)ₚ-(EO—)_{q}—H Formula I

wherein

R represents a chained or branched alkyl having 4 to 10 carbon atoms,

EO represents

—CH₂—CH₂—O—,

PO represents

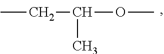

p represents an integer of 1 to 5,

q represents an integer of 1 to 5.

(Step 3) Agitating, dispersing and emulsifying the mixture from mixing tank at 1,000˜1,500 rpm in the homo-agitating part

The mixture of plant oil based emulsion including 95% herbal ethanol extract, if necessary, penetration promoter prepared in Step 2 has been transferred to homo-agitating part. Agitation, dispersion and emulsification of the mixture is made at 1,000˜1,500 rpm in the homo-agitating part.

(Step 4) The filtration and purification of the obtained emulsion through a carbon filter (170)

In this step, the filtration and purification of emulsion obtained in Step 3 can be made through a carbon filter (170).

(Step 5) Softening and cooling the obtained product after passing through a spinning net at a high speed of 10,000˜15,000 rpm

In this step, the obtained product in Step 4 can be softened and cooled after passing through a spinning net at a high speed. The shape of final product can be an emulsion such as yogurt with a viscosity of 120˜140 cPas.

The manufacturing process of the present invention can be described in detail with reference to drawings.

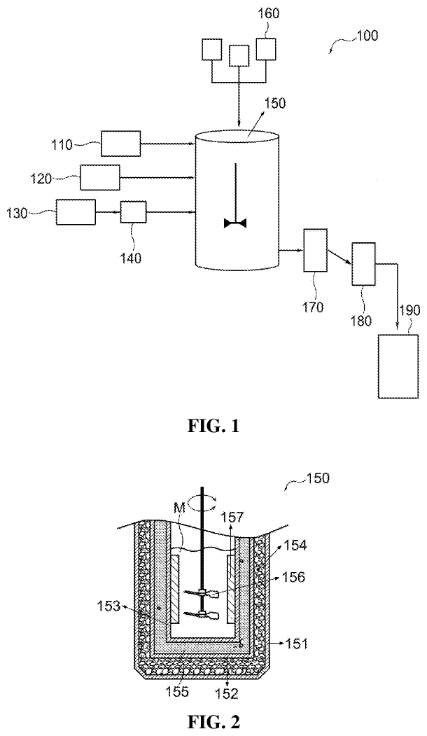

FIG. 1 is a block diagram showing an outline of the apparatus for manufacturing a biocidal pesticide composition of the present invention.

As shown in FIG. 1, the apparatus for manufacturing a biocidal pesticide composition comprises a water storage tank (110), an emulsifier storage tank (120), a plant oil storage tank (130), a pulverizer (140), a mixing tank (150), a herbal extract storage tank (160), a filter (170), a cooler (180), and a manufactured product tank (190).

A water storage tank (110) is a part for storing water to be supplied to the mixing tank (150) and an emulsifier storage tank (120) is a part for storing emulsifier to be supplied to the mixing tank (150). Further, a plant oil storage tank (130) is a part for storing the plant oil to be supplied to the mixing tank (150).

A pulverizer (140) is disposed between plant oil storage tank (130) and mixing tank (150). Further, plant oil discharged from plant oil storage tank (130) can be crashed and pulverized in order to supply into mixing tank (150). The particle size of pulverized plant oil can be 20˜70 nm having a lower viscosity than raw plant oil stored.

FIG. 2 is a cross-sectional view of mixing tank (150) showing its structure.

As shown in FIG. 2, mixing tank (150) includes an outer cylinder (151), an intermediate cylinder (152), an inner cylinder (153), a heat insulating material (154), a heated water part (155), a stirring blade (156) and an elevation plate (157).

As shown in this figure, outer cylinder (151) can be the outer shape of mixing tank (150), while intermediate cylinder (152) can be inserted in an outer cylinder (151). Further, inner cylinder (153) can be inserted in an intermediate cylinder (152).

On the other hand, a heat insulating material (154) can be inserted between outer cylinder (151) and intermediate cylinder (152). A foaming resin can be used as heat insulating material (154) for outside heat insulation. Further, heated water (155) can be supplied between intermediate cylinder (152) and inner cylinder (153). Heated water (155) can be supplied for maintaining the temperature of mixture (M) in inner cylinder (153) to be 50˜60° C.

The stirring blade (156) disposed in inner cylinder (153) is a part for stirring the mixture (M). The elevation plate (157) protruding from the inner surface of inner cylinder (153) can be used for elevating the mixture along the upward direction. The shape of elevation plate (157) can be rectangular panel material.

The present invention can be explained more concretely by following Examples. However, it should be understood that Examples are intended to illustrate but not in any manner to limit the scope of the present invention.

### (Preparation Example 1) Preparation of Biocidal Pesticide Composition of the Present Invention

After mixing 30 g of water and 20 g of emulsifier, 50 g of soybean oil has been added and dispersed to prepare 100 g of soybean oil based emulsion. 5 g of 95% herbal ethanol extract selected from Phytolaccae Radix, Cinnamomi Cortex Spissus, Artemisiae Iwayomogii Herba or Pulvis Sophorae Radicis has been added and suspended in soybean oil based emulsion with 1,200 rpm stirring. Finally, biocidal pesticide composition of the present invention has been prepared after purifying and softening the obtained mixture.

### (Preparation Example 2) Preparation of Biocidal Pesticide Composition of the Present Invention (Addition of Penetration Promoter)

After mixing 30 g of water and 20 g of emulsifier, 50 g of soybean oil has been added and dispersed to prepare 100 g of soybean oil based emulsion. 5 g of 95% herbal ethanol extract selected from Phytolaccae Radix, Cinnamomi Cortex Spissus, Artemisiae Iwayomogii Herba or Pulvis Sophorae Radicis has been added and suspended with 0.5 g of alkanol alkoxylate penetration promoter in soybean oil based emulsion with 1,200 rpm stirring. Finally, biocidal pesticide composition of the present invention has been prepared after purifying and softening the obtained mixture.

### (Comparative Preparation Example 1) Preparation of Biocidal Pesticide Composition (Without Addition of 95% Herbal Ethanol Extract)

After mixing 30 g of water and 20 g of emulsifier, 50 g of soybean oil has been added and dispersed to prepare 100 g of soybean oil based emulsion. Finally, biocidal pesticide composition has been prepared after purifying and softening the obtained mixture.

### (Comparative Preparation Example 2) Preparation of Biocidal Pesticide Composition (Shortage of Soybean Oil Amount)

After mixing 70 g of water and 15 g of emulsifier, 15 g of soybean oil has been added and dispersed to prepare 100 g of soybean oil based emulsion. 5 g of 95% herbal ethanol extract selected from Phytolaccae Radix, Cinnamomi Cortex Spissus, Artemisiae Iwayomogii Herba or Pulvis Sophorae Radicis has been added and suspended in soybean oil based emulsion with 1,200 rpm stirring. Finally, biocidal pesticide composition has been prepared after purifying and softening the obtained mixture.

### (Comparative Preparation Example 3) Preparation of Biocidal Pesticide Composition (Shortage of Emulsifier Amount)

After mixing 47 g of water and 3 g of emulsifier, 50 g of soybean oil has been added and dispersed to prepare 100 g of soybean oil based emulsion. 5 g of 95% herbal ethanol extract selected from Phytolaccae Radix, Cinnamomi Cortex Spissus, Artemisiae Iwayomogii

Herba or Pulvis Sophorae Radicis has been added and suspended in soybean oil based emulsion with 1,200 rpm stirring. Finally, biocidal pesticide composition of has been prepared after purifying and softening the obtained mixture.

### (Example 1) Stability Test

The biocidal pesticide compositions prepared in Preparation Examples 1 and 2 and Comparative Preparation Examples 1 to 3 have been stored at room temperature for 6 months. Then, the formation of precipitate, the size of suspended particles and the change of viscosity have been measured. After visually observing the formation of the precipitate, the judgment has been made either observed (+) or no (−), while the size of the suspended particles of 95% herbal ethanol extract have been measured by electron microscope and expressed in micrometer scale. Further, the change in viscosity has been expressed as follows. 0 represents for less than ±5%, 1 represents for ±5˜10% and 2 represents for more than ±10%. The results have been shown in Table 1 after 6 months observation.

TABLE 1

| | Formation of | Average particle | Change of |
|---|---|---|---|
| | precipitation | size(μm) | viscosity |
| Prep. Ex. 1 | − | 25 ± 9 | 0 |
| Prep. Ex. 2 | − | 18 ± 7 | 0 |
| Com. Prep. Ex. 1 | − | Not measurable | 0 |
| Com. Prep. Ex. 2 | + | 89 ± 25 | 1 |
| Com. Prep. Ex. 3 | + | 168 ± 32 | 2 |

The average size of suspended particles of 95% herbal ethanol extract prepared in Preparation Examples 1 and 2 have been measured as 25±9 μm, 18±7 μm, respectively. Therefore, the average size of suspended particles of 95% herbal ethanol extract have not been larger than 50 μm. It means that the suspended particles of 95% herbal ethanol extract can be stably dispersed without formation of precipitation.

Further, the particle size of 95% herbal ethanol extract prepared in Comparative Preparation Example 1 has not been able to be measured, because suspended particles of 95% herbal ethanol extract have not been included in this composition. On the other hand, the particle size of 95% herbal ethanol extract prepared in Comparative Preparation Example 2 and 3 have been measured larger than 50 μm, which cause the formation of precipitation of 95% herbal ethanol extract.

### (Example 2) Permeability Test

The permeability of plant oil penetration into apple tree leaf has been made after diluting with 100 fold of water with respect to the biocidal pesticide compositions prepared in Preparation Examples 1 and 2 and Comparative Preparation Examples 1 to 3. The experimental protocols are as follows. After collecting and cutting matured apple tree leaves, cuticle film on the upper part of leaves have been separated for measuring permeability. Further, leaves have been placed on Teflon plate. Then, the biocidal pesticide compositions diluted with 100 fold of water have been filled in the cell. The penetration amounts of plant oil into the cuticle have been measured after 5 hours, 10 hours and 20 hours. Upon measuring the penetration amounts of plant oil, the permeability of plant oil into the cuticle has been expressed by the ratio of the amount of plant oil in the cuticle as to total amount of plant oil filled in the cell. The results have been shown in Table 2.

TABLE 2

| | Permeability | Permeability | Permeability |
|---|---|---|---|
| | after | after | after |
| | 5 hours (%) | 10 hours (%) | 20 hours (%) |
| Prep. Ex. 1 | 6 | 16 | 40 |
| Prep. Ex. 2 | 7 | 18 | 48 |
| Com. Prep. Ex. 1 | 5 | 15 | 33 |
| Com. Prep. Ex. 2 | 2 | 7 | 11 |
| Com. Prep. Ex. 3 | 6 | 12 | 27 |

As shown in Table 2, the biocidal pesticide composition of Preparation Example 2 containing penetration promoter exhibited the best plant oil permeability. On the other hand, both the biocidal pesticide compositions of Comparative Preparation Example 2 and 3 have shown the lower plant oil permeability.

### (Example 3) Fungicidal Activity Test

Fungicidal activity test as to powdery mildew (Leveillula taurica) and gray mold (Botrytis Cinerea) has been made after diluting with 100 fold of water with respect to the biocidal pesticide compositions prepared in Preparation Examples 1 and 2 and Comparative Preparation Examples 1 to 3. The experimental protocols are as follows.

After inoculating the spore suspensions of powdery mildew (Leveillula taurica) and the gray mold (Botrytis Cinerea) into the plant, the test plant has been transferred to the humidifying chamber. The 100 fold diluted solutions of biocidal pesticide compositions prepared in Preparation Examples 1 and 2 and Comparative Preparation Examples 1 to 3 have been sprayed in an amount of 10 cc/m² into the test plants. The fungicidal activity has been measured by percentage of fungi controlled area as to sprayed plant area. The larger percentage of controlled area means the better fungicidal activity.

Table 3 shows the control effect of powdery mildew (Leveillula taurica) and gray mold (Botrytis cinerea).

TABLE 3

| | Powdery mildew | Gray mold |
|---|---|---|
| Prep. Ex. 1 | 56 ± 7% | 43 ± 8% |
| Prep. Ex. 2 | 69 ± 8% | 47 ± 6% |
| Com. Prep. Ex. 1 | 23 ± 5% | 19 ± 4% |
| Com. Prep. Ex. 2 | 27 ± 4% | 20 ± 6% |
| Com. Prep. Ex. 3 | 34 ± 7% | 40 ± 5% |

As shown in Table 3, the biocidal pesticide composition prepared in Preparation Example 2 showed the most excellent control effect. On the other hand, all of the biocidal pesticide compositions prepared in Comparative Preparation Examples 1, 2 and 3 exhibited significantly reduced fungicidal activity against Leveillula taurica and Botrytis Cinerea than the biocidal pesticide compositions prepared in the Preparation Examples.

### INDUSTRIAL APPLICABILITY

A biocidal pesticide composition comprising at least one herbal extract selected from Phytolaccae Radix, Cinnamomi Cortex Spissus, Artemisiae Iwayomogii Herba or Pulvis Sophorae Radicis suspended in plant oil based emulsion can be industrially applicable, due to its fungicidal or insecticidal activity.

1.-7. (canceled)

8. A process for preparing a biocidal pesticide composition having fungicidal or insecticidal activity comprising:
i) preparing 100 wt part of a plant oil based emulsion comprising 40-60 wt % of plant oil, 5-30 wt % of an emulsifier and 20-55 wt % of water;
ii) adding and suspending 1-20 wt part of at least one herbal extract of 95% ethanol selected from Phytolaccae Radix, Cinnamomi Cortex Spissus, or Artemisiae Iwayomogii Herba into the plant oil based emulsion prepared in step i); and
iii) adding and mixing 0.01-1.0 wt part of an alkanol alkoxylate penetration promoter represented by the following formula (I) for smooth penetration of biocidal pesticide composition in the crops;
R—O—(—PO—)ₚ-(EO—)_{q}—H Formula I
wherein R represents a chained or branched alkyl having 4 to 10 carbon atoms,
EO represents
—CH₂—CH₂—O—,
PO represents 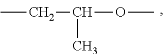
p represents an integer of 1 to 5, and
q represents an integer of 1 to 5.

9. The process for preparing a biocidal pesticide composition according to claim 1, wherein said plant oil is soybean oil.

10. The process for preparing a biocidal pesticide composition according to claim 1, wherein said emulsifier is propylene glycol laurate monoester.

11. The process for preparing a biocidal pesticide composition according to claim 1, wherein an average particle size of said herbal extract of 95% ethanol is 1-50 micrometers.
